(19) United States
(12) Patent Application Publication
(10) Pub. No.: US 2012/0287282 A1
(43) Pub. Date: Nov. 15, 2012

(54) IMAGE PROCESSING APPARATUS, IMAGE PROCESSING SYSTEM, AND IMAGE PROCESSING METHOD

(75) Inventors: Kohtaroh Kinoshita, Kobe-shi (JP); Sunja Imu, Kobe-shi (JP)

(73) Assignee: FUJITSU TEN LIMITED, Kobe-shi, Hyogo (JP)

(21) Appl. No.: 13/574,021

(22) PCT Filed: Jan. 13, 2011
(86) PCT No.: PCT/JP2011/050410

§ 371 Date: Jul. 19, 2012

(30) Foreign Application Priority Data
Jan. 19, 2010 (JP) 2010-008827

(51) Int. Cl. H04N 7/18

(52) U.S. Cl. 348/148; 348/E07.085

(57) ABSTRACT

An image processing apparatus to be mounted on a vehicle is provided with an image obtaining means, a synthetic image generating means, and a model image supplying means. The image obtaining means is for obtaining a plurality of camera images captured by a plurality of cameras installed on the vehicle. The synthetic image generating means is for generating, on the basis of the plurality of camera images, a plurality of synthetic images viewed from one viewpoint among a plurality of viewpoints that are different from each other, and which indicate the surroundings of the vehicle. The model image supplying means is for outputting, to a display device installed on the vehicle, information corresponding to a model image wherein one field-of-view range associated with the one viewpoint among the plurality of viewpoints is indicated selectively, from among a plurality of field-of-view ranges.

### TECHNICAL FIELD

The present invention relates to a technology to display an image on a display device installed in a vehicle.

### BACKGROUND ART

Generally, there is a device that enables a user to monitor a periphery of a vehicle through obtaining images of the periphery of the vehicle through cameras installed on the vehicle and displaying the obtained images on a display device automatically or by a user's operation. Further, for example, Japanese Patent Application Laid-Open Publication No. 2004-32464 [Patent Document 1] discloses a technology in which a vehicle periphery monitoring device is provided with a conversion button configured to adjust an angle of a virtual viewpoint, such that images captured through cameras can be provided as images viewed from a plurality of virtual viewpoints that are different from viewpoints of cameras.

### SUMMARY OF INVENTION

### Problems to be Solved by Invention

However, according to the vehicle periphery monitoring technology disclosed in the related art, a synthetic image is displayed on a display device after a viewpoint position of a virtual viewpoint is adjusted using a conversion button, and then a user confirms whether the synthetic image is a desired image. It is cumbersome in that if the synthetic image is not displayed within a desired range, a user should repeat from the start the process of adjusting a viewpoint position of a virtual viewpoint using a conversion button on a setup screen.

In consideration of the above technical problem, the present invention has been made in an effort to provide a technology that enables a user to grasp at a glance which area of the surroundings of a vehicle will be displayed on a display device as a synthetic image.

### Means for Solving Problems

In order to solve the above problem, the following may be provided according to the present invention.

(1): An image processing apparatus configured to be installed in a vehicle, comprising: an image obtaining means configured to obtain a plurality of camera images captured by a plurality of cameras installed on the vehicle; a synthetic image generating means configured to generate, on the basis of the plurality of camera images, a plurality of synthetic images viewed from one viewpoint among a plurality of viewpoints that are different from each other, and which indicate surroundings of the vehicle; and a model image supplying means configured to output, to a display device installed on the vehicle, information corresponding to a model figure in which one field-of-view range associated with the one viewpoint among the plurality of viewpoints is indicated selectively, from among a plurality of field-of-view ranges.

(2): The image processing apparatus according to (1), in which: one viewpoint among the plurality of viewpoints associated with one field-of-view range selected from among the plurality of field-of-view ranges is displayed in the model image in a different mode from other viewpoints among the plurality of viewpoints.

(3): The image processing apparatus according to (1) or (2), in which: a dead angle in one field-of-view range selected from among the plurality of field-of-view ranges is displayed on the model image in a different mode from other regions among the plurality of field-of-view ranges.

(4): The image processing apparatus according to any one of (1) to (3), further comprising a synthetic image providing means configured to output, to the display device, information corresponding to the one synthetic image of the plurality of synthetic images associated with the one field-of-view range selected from among the plurality of field-of-view ranges.

(5): An image processing system configured to be installed on a vehicle, comprising: a plurality of cameras configured to be mounted on a vehicle; an image processing apparatus configured to be installed on a vehicle, the image processing apparatus comprising: an image obtaining means configured to obtain a plurality of camera images captured by a plurality of cameras installed on the vehicle; a synthetic image generating means configured to generate, on the basis of the plurality of camera images, a plurality of synthetic images viewed from one viewpoint among a plurality of viewpoints that are different from each other and which indicate surroundings of the vehicle; and a model image supplying means configured to output, to a display device installed on the vehicle, information corresponding to a model figure in which one field-of-view range associated with the one viewpoint among the plurality of viewpoints is indicated selectively, from among a plurality of field-of-view ranges.

(6): An image processing method, comprising: obtaining a plurality of camera images captured by a plurality of cameras installed on the vehicle; generating, on the basis of the plurality of camera images, a plurality of synthetic images viewed from a plurality of viewpoints that are different from each other and which indicate surroundings of the vehicle; and outputting, to a display device installed on the vehicle, information corresponding to a model image in which one field-of-view range associated with the one viewpoint among the plurality of viewpoints is indicated selectively, from among a plurality of field-of-view ranges.

### Advantageous Effects of Invention

With the configuration of (1) to (6), it is possible to output, to a display device, information corresponding to a model image in which a field-of-view range from a virtual viewpoint for a vehicle is indicated selectively. Further, by outputting, to a display device, information corresponding to a model image of a changed field-of-view range according to the operation of selecting a viewpoint position of a virtual viewpoint, it is possible to grasp at a glance which area around a vehicle will be displayed to a display device as a synthetic image on the basis of viewpoint positions of virtual viewpoints. Through this, a user can avoid a cumbersome process in which, after setting up a position of a virtual viewpoint to be displayed as a synthetic image, if the synthetic image is not a desired image, the user should repeat the setup process from the start.

In addition, with the configuration of (2), it is possible for a user to see on a display device and grasp at a glance a viewpoint position being selected.

More specifically, with the configuration of (3), it is possible for a user to grasp at a glance a dead angle area which is not seen from a virtual viewpoint selected by a user.

Further, specifically with the configuration of (4), it is possible to set up a viewpoint position while confirming simultaneously a model image indicating a field-of-view range from a virtual viewpoint for a vehicle and a synthetic image generated on the basis of a viewpoint position of a virtual viewpoint selected by a user.

### BRIEF DESCRIPTION OF DRAWINGS

FIG. 1 is a diagram illustrating the configuration of an image processing system.

FIG. 2 is a view illustrating positions on which vehicle cameras are installed in a vehicle.

FIG. 3 is a view illustrating a technique of generating a synthetic image.

FIG. 4 is a diagram illustrating transition of an operating mode an image processing system.

FIG. 5 is a view illustrating Example 1 of a model image.

FIG. 6 is a view illustrating Example 2 of a model image.

FIG. 7 is a view illustrating Example 1 in which both of a model image and a synthetic image are displayed.

FIG. 8 is a view illustrating Example 2 in which both of a model image and a synthetic image are displayed.

FIG. 9 is a flow chart illustrating a setup process of viewpoint positions in a model image.

### MODE TO CARRY OUT INVENTION

Hereinafter, exemplary embodiments of the present invention will be described in detail with reference to the accompanying drawings.

<1-1. System Configuration>

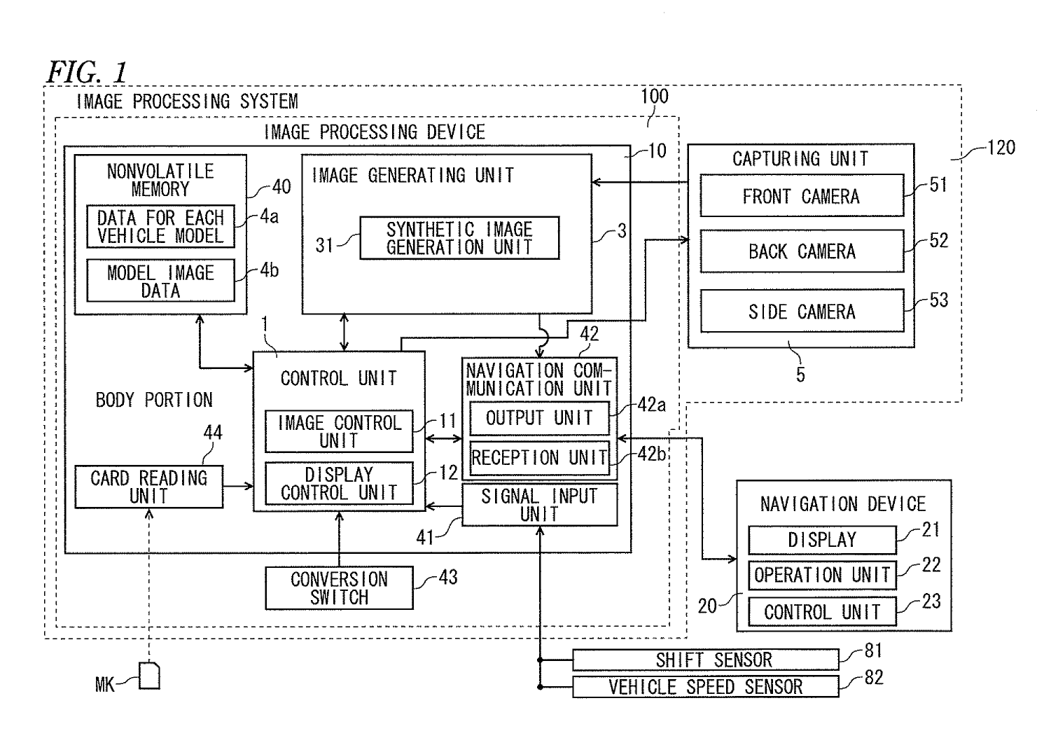

FIG. 1 is a block diagram illustrating the configuration of an image processing system 120. This image processing system 120 is installed in a vehicle (in an embodiment of the present invention, a car), and has a function of generating an image through capturing images of a periphery of a vehicle and outputting the generated image to a display device such as a navigation device 20 in a cabin. A user (representatively, a driver) of the image processing system 120 can grasp the appearance of the periphery of the vehicle substantially in real time by using the image processing system 120.

As illustrated in FIG. 1, the image processing system 120 mainly includes an image processing apparatus 100 configured to generate peripheral images showing the periphery of the vehicle and to output image information to a display device such as a navigation device 20 and the like, and a capturing unit 5 configured to be provided with cameras capturing images around the vehicle.

The navigation device 20 performs navigation guidance for a user, and includes a display 21 such as a liquid crystal display having a touch panel function, an operation unit 22 for user's operation, and a control unit 23 for controlling the whole device. The navigation device 20 is provided on an instrument panel or the like of the vehicle so that the user can recognize the screen of the display 21. Various kinds of instructions from the user are received by the operation unit 22 and the display 21 as the touch panel. The control unit 23 is configured as a computer having a CPU, a RAM, a ROM, and the like, and various kinds of functions including the navigation function are realized as the CPU performs arithmetic processing according to a predetermined program.

The navigation device 20 is communicably connected with the image processing apparatus 100, and performs transmission and reception of various kinds of control signals with the image processing apparatus 100 and reception of peripheral images generated by the image processing apparatus 100. On the display 21, while images based on the stand-alone function of the navigation device 20 are typically displayed by the control of the control unit 23, the peripheral images showing the appearance of the periphery of the vehicle generated by the image processing apparatus 100 are displayed under a predetermined condition. Through this, the navigation device 20 also functions as a display device for receiving and displaying the peripheral images generated by the image processing apparatus 100.

The image processing apparatus 100 includes a body portion 10 in which an ECU (Electronic Control Unit) having a function of generating peripheral images is provided, and is arranged on a predetermined position of the vehicle. The image processing system 120 is provided with the capturing unit 5 capturing the images of the periphery of the vehicle, and functions as an image generation device that generates synthetic images viewed from a virtual viewpoint on the basis of the captured images obtained by capturing the image of the periphery of the vehicle through the capturing unit 5. Vehicle cameras 51, 52, and 53 provided in the capturing unit 5 are arranged on appropriate positions of the vehicle, which differ from the body portion 10, and the details thereof will be described later.

The body portion 10 of the image processing apparatus 100 mainly includes a control unit 1 controlling the whole device, an image generating unit 3 generating the peripheral images for display by processing the captured images acquired by the capturing unit 5, and a navigation communication unit 42 communicating with the navigation device 20.

Various kinds of instructions from the user, which are received by the operation unit 22 or the display 21 of the navigation device 20, are received by the navigation communication unit 42 to be input to the control unit 1 as control signals. Further, the image processing apparatus 100 includes a conversion switch 43 that receives an instruction to switch the display contents from the user. The signal that indicates the user's instruction is also input from the conversion switch 43 to the control unit 1. Through this, the image processing apparatus 100 can operate in response to both the user's operation with respect to the navigation device 20 and the user's operation with respect to the conversion switch 43. The conversion switch 43 is arranged on an appropriate position of the vehicle that differs from the body portion 10.

The image generating unit 3 is configured as a hardware circuit that can perform various kinds of image processing, and includes a synthetic image generating unit 31.

The image generating unit 3, serving as an image obtaining means in the present invention, obtains a plurality of captured images (camera images in the present invention) acquired by the capturing unit 5. The synthetic image generating unit 31, serving as a synthetic image generating means in the present invention, generates the synthetic images viewed from a certain virtual viewpoint around the vehicle on the basis of a plurality of captured images acquired by a plurality of vehicle cameras 51, 52, and 53 of the capturing unit 5. The technique of generating the synthetic images viewed from the virtual viewpoint through the synthetic image generating unit 31 will be described later.

The image generating unit 3 and a navigation communication unit 42, serving as a synthetic image providing means and a model image providing means in the present invention, includes: an output unit 42a that outputs, to the navigation device 20 (a display device in the present invention), image information corresponding to a synthetic image generated by the image generating unit 3 or, a model image indicating a field-of-view range from a virtual viewpoint of the synthetic image; and a reception unit 42b that receives information input by a user from the display 21 having a touch panel function or from the operation unit 22. Herein a model image refers to an image in which a plurality of possible viewpoint positions of virtual viewpoints which can be selected by a user for an image of a model vehicle imitating a real vehicle are indicated, and the viewpoint positions can be changed by a user using a viewpoint position change icon. Further, the viewpoint position can be changed to a certain viewpoint position of virtual viewpoint by using the display 21 having a touch panel function, or the operation unit 22. Hereinafter, a synthetic image along with a model image refers to image information.

Image information is output from output unit 42a according to image information output instruction signal of control unit 1. Upon receiving the signal, for example, a model image, which can be displayed by a synthetic image, and indicates a field-of-view range from a virtual viewpoint for a vehicle, is output. Through this, a user can confirm a model image that indicates a field-of-view range from a virtual viewpoint displayed on the navigation device 20 as a synthetic image.

In addition, an output unit 42a can also output, to the navigation device 20, a synthetic image along with a model image mentioned above. Through this, a model image indicating a field-of-view range from a virtual viewpoint for a vehicle, and a synthetic image generated on the basis of a viewpoint position of a virtual viewpoint selected by a user are displayed on one screen of the navigation device 20 to be confirmed when setting up a viewpoint.

With a model image displayed on the navigation device 20, a reception unit 42 receives from a user a change in the viewpoint position of a virtual viewpoint, which will be described later. As a result, a model image with a changed viewpoint position of a virtual viewpoint is output from the output unit 42a.

The control unit 1 is configured as a computer having a CPU, a RAM, a ROM, and the like, and various kinds of control functions are realized as the CPU performs arithmetic processing according to a predetermined program. The image control unit 11 and the display control unit 12 shown in the drawing corresponds to one of functions of the control unit 1 realized as described above.

The image control unit 11 controls the image processing that is executed by the image generating unit 3. For example, the image control unit 11 instructs various kinds of parameters that are required to generate the synthetic images generated by the synthetic image generating unit 31.

The display control unit 12 is configured to perform control mostly in the case of displaying, on the navigation device 20, image information processed by the image processing device 100. For example, the display control unit 12 performs control when outputting, to the navigation device 20, synthetic image information generated in the synthetic image generating unit 31, or when outputting a model image to the navigation device 20.

Further, the body portion 10 of the image processing device 100 additionally includes the nonvolatile memory 40, a card reading unit 44, and a signal input unit 41, which are connected to the control unit 1.

The nonvolatile memory 40 is configured as a flash memory or the like that can maintain the stored contents even when the electric power is turned off. In the nonvolatile memory 40, data 4a for each vehicle model and model image data 4b are mostly stored.

The data 4a for each vehicle model may be data according to the vehicle model that is required when the synthetic image generating unit 31 generates the synthetic images.

Further, model image data 4b may be data that includes a vehicle for each vehicle model image, possible viewpoint positions of a plurality of virtual viewpoints, and possible viewpoint position change icon to change viewpoint positions by a user's operation, and the like. According to the instruction signal to output image information, the model image data 4b is output through an output unit 42a to the navigation device 20.

The card reading unit 44 reads a memory card MK that is a portable recording medium. The card reading unit 44 includes a card slot in which the memory card MK is detachably mounted, and reads data recorded on the memory card MK that is mounted in the card slot. The data read by the card reading unit 44 is input to the control unit 1.

The memory card MK is composed of a flash memory or the like that can store various kinds of data, and the image processing apparatus 100 can use the various kinds of data stored in the memory card MK. For example, by storing a program in the memory card MK and reading the program from the memory card MK, it is possible to update the program (firmware) that realizes the function of the control unit 1. Further, by storing, in the memory card MK, data for each vehicle model that corresponds to a vehicle model that is different from that of the data 4a for each vehicle model stored in the nonvolatile memory 40, and reading and storing the data in the nonvolatile memory 40, it is possible to make the image processing system 120 correspond to a different kind of vehicle model.

Further, signals from various kinds of devices provided in the vehicle are input to the signal input unit 41. Through this signal input unit 41, the signals from the outside of the image display system 120 are input to the control unit 1. Specifically, the signals indicating various kinds of information are input from a shift sensor 81, a vehicle speed sensor 82, and the like.

From the shift sensor 81, positions of operations of a shift lever of a transmission of the vehicle 9, that is, shift positions of “P (Park)”, “D (Drive)”, “N (Neutral)”, and “R (Reverse)”, are input. From the vehicle speed sensor 82, a traveling speed (km/h) of the vehicle 9 at that time is input:

<1-2. Capturing Unit>

Then, the capturing unit 5 of the image processing system 120 will be described in detail. The capturing unit 5 is electrically connected to the control unit 1, and operates on the basis of the signal from the control unit 1.

The capturing unit 5 includes vehicle cameras, that is, a front camera 51, a back camera 52, and side cameras 53. The vehicle cameras 51, 52, and 53 are provided with image pickup devices, such as CCD or CMOS, and electronically obtain images.

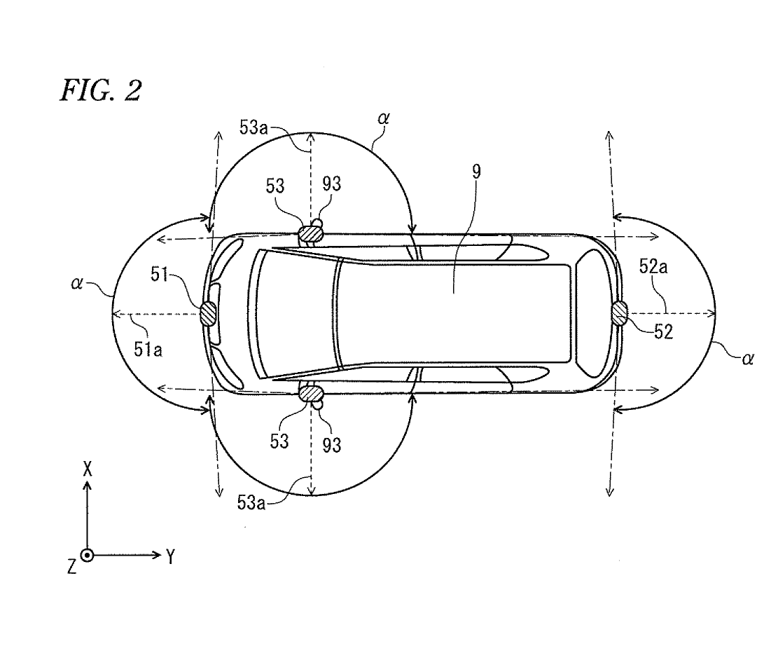

FIG. 2 is a view illustrating positions on which the vehicle cameras 51, 52, and 53 are installed. In the following description, when describing the orientation and direction, three-dimensional XYZ orthogonal coordinates as shown in the drawing are appropriately used. The XYZ axes are relatively fixed against the vehicle 9. Here, the X-axis direction is along the left/right direction of the vehicle 9, the Y-axis direction is along the forward/rearward direction of the vehicle 9, and the Z-axis direction is along the vertical direction. Further, for convenience, it is assumed that +X side is the right side of the vehicle 9, +Y side is the rear side of the vehicle 9, and +Z side is the upper side.

The front camera 51 is provided in the vicinity of the mounting position of the vehicle license plate at the front end of the vehicle 9, and its optical axis 51a is directed in the straight direction (−Y side in the Y-axis direction as viewed in a plane) of the vehicle 9. The back camera 52 is provided in the vicinity of the mounting position of the vehicle license plate at the rear end of the vehicle 9, and its optical axis 52a is directed in the opposite direction (+Y side in the Y-axis direction as viewed in a plane) of the straight direction of the vehicle 9. Further, the side cameras 53 are provided on the left and right door mirrors 93, and its optical axis 53a is directed to the outside along the left/right direction (the X-axis direction as viewed in a plane) of the vehicle 9. On the other hand, although it is preferable that the attachment position of the front camera 51 or the back camera 52 is substantially at the center of the vehicle, it may be shifted somewhat to the left or right direction from the center of the vehicle.

Fish-eye lenses are adopted as lenses of the vehicle cameras 51, 52, and 53, and the vehicle cameras 51, 52, and 53 have an angle a of view of 180 degrees or more. Accordingly, by using the four vehicle cameras 51, 52, and 53, it is possible to capture images of the whole periphery of the vehicle 9.

<1-3. Image Conversion Processing>

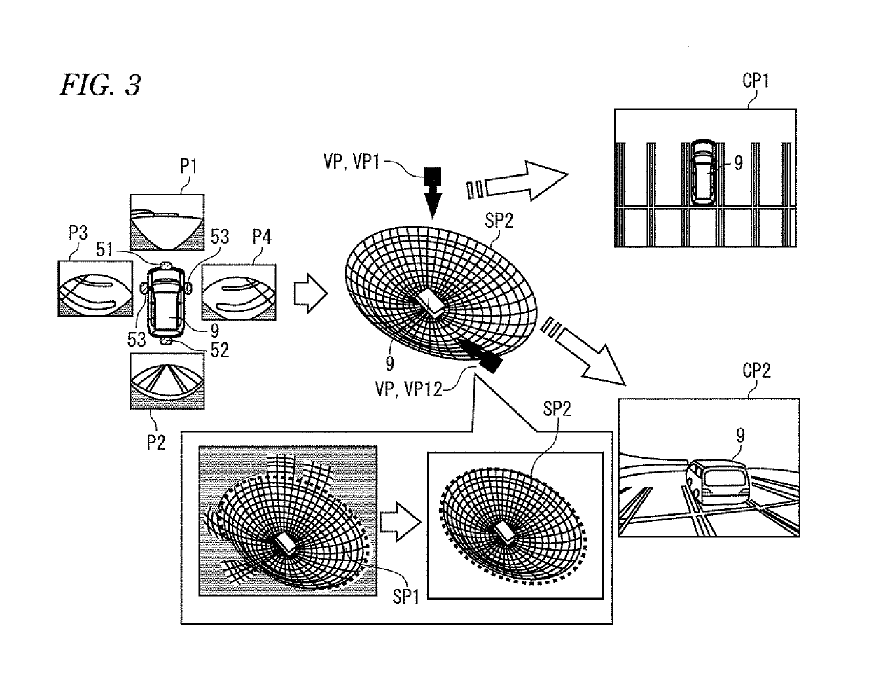

Then, a technique in which the synthetic image generating unit 31 of the image generating unit 3 generates synthetic images showing the appearance of the periphery of the vehicle 9 viewed from a certain virtual viewpoint on the basis of captured images obtained by the capturing unit 5 will be described. In the case of generating the synthetic images, data for each vehicle model pre-stored in the nonvolatile memory 4a is used. FIG. 3 is a view illustrating the technique of generating synthetic images.

If image capturing is performed simultaneously in the front camera 51, the back camera 52, and the side camera 53 of the capturing unit 5, four captured images P1 to P4 showing the front, rear, left, and right sides of the vehicle 9 are obtained. That is, the four captured images P1 to P4 obtained by the capturing unit 5 contain information showing the whole periphery of the vehicle 9 at the time of capturing.

Then, respective pixels of the four captured images P1 to P4 are projected onto a three-dimensional (3D) curved surface SP2 in a virtual three-dimensional space. The 3D curved surface SP2, for example, is substantially in a hemispheric shape (bowl shape), and the center portion thereof (the bottom portion of the bowl) is determined as the position in which the vehicle 9 is present. The correspondence relationship has been determined in advance between the positions of the respective pixels included in the captured images P1 to P4 and the positions of the respective pixels of the 3D curved surface SP2. Accordingly, the values of the respective pixels of the 3D surface SP2 can be determined on the basis of the values of the respective pixels included in the captured images P1 to P4.

On the other hand, in capturing the images P1 to P4, wide-angle cameras having an angle a of view of 180 degrees or more are used as the vehicle cameras 51, 52, and 53. In the case of capturing images using such a wide-angle camera, a part of the images may be blocked by an obstacle, such as a hood or a filter frame of the camera, to cause the reduction of light intensity in the peripheral area, and thus shading (a part having low brightness in the camera image) that is not intended by a photographer may occur on the screen. This shading phenomenon is generally called mechanical vignetting.

The 3D curved surface SP1 shown in FIG. 3 shows a state where the shading, which is caused by the reduction of the light intensity in a specified area around the 3D curved surface SP1, onto which the captured images P1 to P4 have been projected, occurs due to the occurrence of the mechanical vignetting on the part of the captured images. If the 3D curved surface having the shading is displayed on the navigation device 20 as it is, the synthetic images viewed from the predetermined virtual viewpoint may not be substantially in a hemispheric shape (bowl shape).

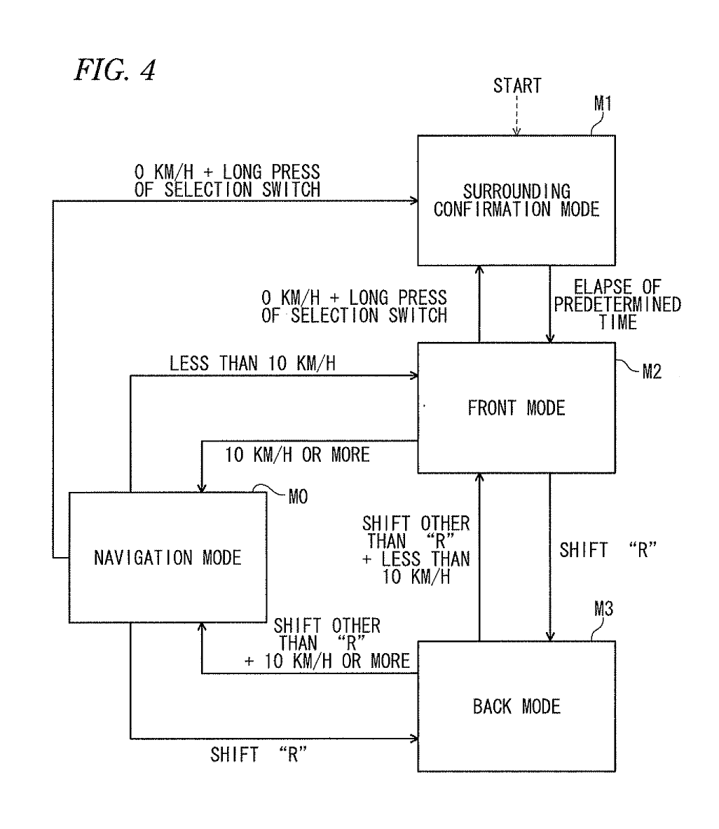

Due to this, synthetic images that correspond to a certain virtual viewpoint are generated using a 3D curved surface SP2 which is a center area that is substantially in a hemispheric shape (bowl shape) except for the peripheral area in which reduction of the light intensity occurs due to the mechanical vignetting of the 3D curved surface SP1. For example, as shown in FIG. 4, the 3D curved surface SP2 is determined by removing the peripheral area in which the reduction of the light intensity occurs due to the mechanical vignetting considering a dashed portion as a boundary of the 3D curved surface SP1. Through this, the images of the object that are substantially in a hemispheric shape (bowl shape) can be formed, and thus the images can be provided, from which a user can grasp the positional relationship between the vehicle and the obstacle that are displayed in 3D as if the user saw the top face down bowl from above.

The processing in the case where the light intensity is reduced due to the mechanical vignetting has been described as an example. However, the processing can also be applied in the case where the reduction of the light intensity except for the mechanical vignetting (for example, reduction of the light intensity due to optical vignetting) occurs.

Further, the correspondence relationship between the positions of the respective pixels of the captured images P1 to P4 and the positions of the respective pixels of the 3D curved surface SP depends on the arrangement (mutual distance, height above ground, optical axis angle, and the like) of the four vehicle cameras 51, 52, and 53 on the vehicle 9. Because of this, table data that indicates the correspondence relationship is included in the data 4a for each vehicle model stored in the nonvolatile memory 40.

Further, polygon data that indicates the shape or size of the vehicle body included in the data 4a for each vehicle model is used, and a vehicle image that is a polygon model that shows the 3D shape of the vehicle 9 is virtually configured. The configured vehicle image is arranged in the center portion of the substantially hemispheric shape that corresponds to the position of the vehicle 9 in the 3D space in which the 3D curved surface SP is set.

Further, in the 3D space in which the 3D curved surface SP is present, the virtual viewpoint VP is set by the control unit 1. The virtual viewpoint VP is defined by the viewpoint position and the viewing direction, and is set at a certain viewpoint position that corresponds to the periphery of the vehicle and toward a certain viewing direction in the 3D space.

Then, depending on the set virtual viewpoint VP, a necessary area in the 3D curved surface SP2 as described above is cut off as the image. The relationship between the virtual viewpoint VP and the necessary area in the 3D curved surface SP is predetermined and pre-stored in the nonvolatile memory 40 as the table data. On the other hand, rendering is performed with respect to the vehicle image configured as a polygon to correspond to the set virtual viewpoint VP, and two-dimensional (2D) vehicle image that is the result of the rendering overlaps the cut image. Through this, synthetic images showing the appearance of the vehicle 9 and the periphery of the vehicle 9 viewed from a certain virtual viewpoint are generated.

For example, if a virtual viewpoint VP11 is set in a state where the viewpoint position is a position directly above almost the center of the position of the vehicle 9, and the viewing direction is almost directly below of the vehicle 9, a synthetic image CP1 showing the appearance of the vehicle 9 (actually, vehicle image) and the periphery of the vehicle 9 viewed downward from almost directly above of the vehicle 9 is generated. Further, as shown in the drawing, if a virtual viewpoint VP2 is set in a state where the viewpoint position is the left rear of the position of the vehicle 9, and the viewing direction is almost front of the vehicle 9, a synthetic image CP2 showing the appearance of the vehicle 9 (actually, vehicle image) and the periphery of the vehicle 9 viewed from the left rear of the vehicle 9 to the whole periphery thereof is generated.

On the other hand, in the case of actually generating the synthetic images, it is not necessary to determine the values of all the pixels of the 3D curved surface SP2, but by determining only the values of the pixels of the area that becomes necessary to correspond to the set virtual viewpoint VP on the basis of the captured images P1 to P4, the processing speed can be improved.

<1-4. Operating Mode>

Then, the operating mode of the image processing system 120 will be described. FIG. 4 is a diagram illustrating transition of an operating mode in an image processing system 120. The image processing system 120 has four operating modes of a navigation mode M0, a surrounding confirmation mode M1, a front mode M2, and a back mode M3. These operating modes are switched under the control of the control unit 1 depending on the operation of the driver or the traveling state of the vehicle 9.

The navigation mode M0 is an operating mode in which a map image for a navigation guide is displayed on the display 21 by the function of the navigation device 20. In the navigation mode M0, the function of the image processing device 100 is not used, but various kinds of display are performed by the function of the navigation device 20 itself. Accordingly, in the case where the navigation device 20 has a function of receiving and displaying radio waves of television broadcasting, a television broadcasting screen may be displayed instead of the map image for the navigation guide.

By contrast, the surrounding confirmation mode M1, the front mode M2, and the back mode M3 are operating modes in which a display image showing the situation of the periphery of the vehicle 9 in real time is displayed on the display 21 using the function of the image processing device 100.

The surrounding confirmation mode M1 is an operating mode to perform animated representation that shows orbiting around the vehicle 9 as viewing the vehicle 9 downward. The front mode M2 is an operating mode in which a display image showing mainly the front or side of the vehicle 9 that is necessary during the forward movement of the vehicle 9 is displayed. Further, the back mode M3 is an operating mode in which a display image showing mainly the rear of the vehicle 9 that is necessary during the backward movement of the vehicle 9 is displayed.

When the image processing system 120 starts, the surrounding confirmation mode M1 is initially set. In the case of the surrounding confirmation mode M1, if a predetermined time (for example, 6 seconds) elapses after performing the animated representation that shows orbiting around the vehicle 9, the mode is automatically switched to the front mode M2. Further, in the case of the front mode M2, if the selection switch 43 is continuously pressed for a predetermined time in a state of 0 km/h (stopped state), the mode is switched to the surrounding confirmation mode M1. On the other hand, the mode may be switched from the surrounding confirmation mode M1 to the front mode M2 by a predetermined instruction from the driver.

Further, in the case of the front mode M2, if the traveling speed becomes, for example, 10 km/h or more, the mode is switched to the navigation mode M0. By contrast, in the case of the navigation mode M0, if the traveling speed input from vehicle speed sensor 82 becomes, for example, less than 10 km/h, the mode is switched to the front mode M2.

In the case where the traveling speed of the vehicle 9 is relatively high, the front mode M2 is released in order to allow the driver to concentrate on driving. By contrast, in the case where the traveling speed of the vehicle 9 is relatively low, the driver may drive a vehicle with more consideration of the situation around the vehicle 9, specifically, approaching to the intersection with poor visibility, changing directions, or moving toward the roadside. Due to this, in the case where the traveling speed is relatively low, the mode is switched from the navigation mode M0 to the front mode M2. On the other hand, in the case where the mode is switched from the navigation mode M0 to the front mode M2, the condition that there is an explicit operation instruction from the driver may be added to the condition that the traveling speed is less than 10 km/h.

Further in the case of the navigation mode M0, if the selection switch 43 is continuously pressed for a predetermined time, for example, in a state of 0 km/h (stopped state), the mode is switched to the surrounding confirmation mode M1. Further, if a predetermined time (for example, 6 seconds) elapses after performing the animated representation that shows orbiting around the vehicle 9, the mode is automatically switched to the front mode M2.

Further, in the case of the navigation mode M0 or the front mode M2, if the position of the shift lever that is input from the shift sensor 81 is “R (Reverse)”, the mode is switched to the back mode M3. That is, if the transmission of the vehicle 9 is operated to the position of “R (Reverse)”, the vehicle 9 moves backward, and thus the mode is switched to the back mode M3 mainly showing the rear of the vehicle 9.

On the other hand, in the case of the back mode M3, if the position of the shift lever is any position except for “R (Reverse)”, the mode is switched to the navigation mode M0 or the front mode M2 on the basis of the traveling speed at that time. That is, if the traveling speed is 10 km/h or more, the mode is switched to the navigation mode M0, while if the traveling speed is less than 10 km/h, the mode is switched to the front mode M2.

<1-5. Model Image>

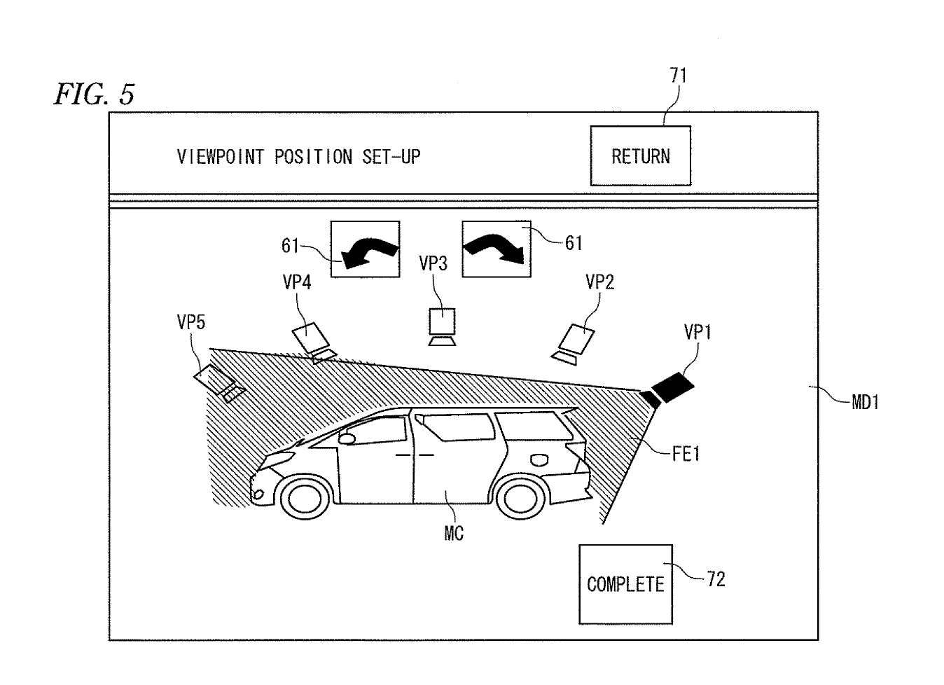

Then, the model image that is output from the output unit 42a of the navigation communication unit 42 provided in the image processing device 100, to be displayed on the navigation device 20 will be described with reference to FIG. 5 illustrating Example 1 of the model image.

In a model image MD1 shown in FIG. 5, possible viewpoint positions VP1 to VP5 of a plurality of virtual viewpoints for a model vehicle MC are provided. By a user's operation of the viewpoint position change icon 61, a viewpoint position is changed to a certain position among the possible viewpoint positions. Further, the operation is performed using the display 21 having a touch panel function or the operation unit 22 of the navigation device 20.

In the example shown in FIG. 5, a viewpoint position VP1 that is placed in the rear is selected, and a field-of-view range FE1 from the viewpoint position VP1 is shown in oblique lines. The field-of-view range, for example, corresponds to a display range of a synthetic image that is displayed on the navigation device 20 in the back mode or front mode as described above.

A return button 71 may be chosen by a user when returning to a previous set-up screen which is not shown. In addition, a complete button 72 may be chosen by a user when returning to a previous set-up screen which is not shown, after information on changed positions is stored in the nonvolatile memory 40. Further, on the basis of a set viewpoint position of a virtual viewpoint, a synthetic image is displayed in the back mode or front mode as described above.

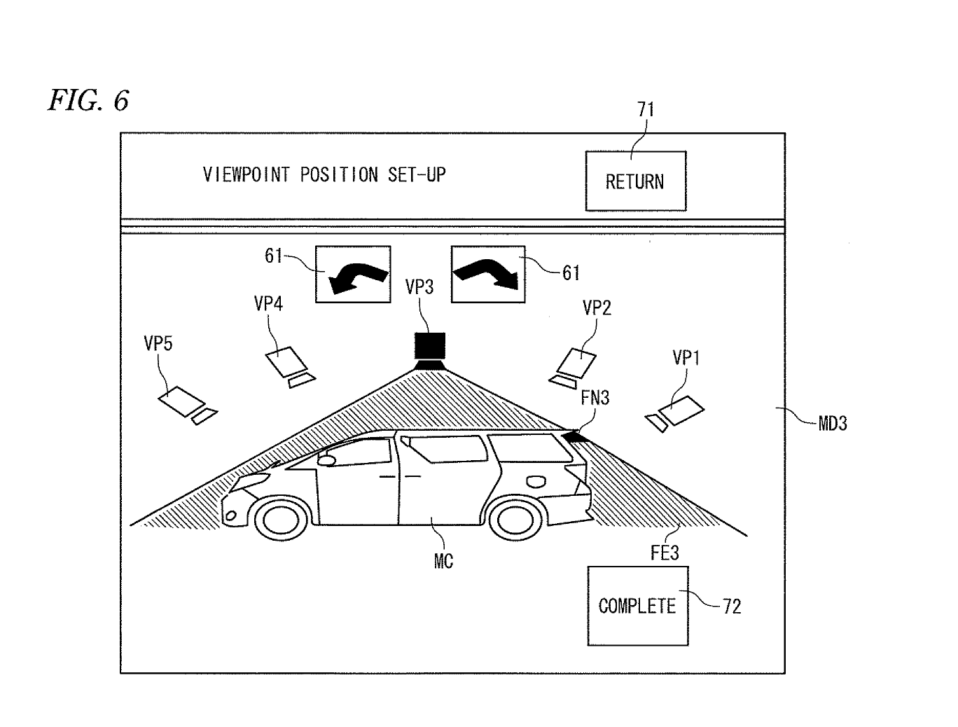

Then, a model image that indicates a field-of-view range from a different viewpoint position will be described as Example 2 with reference to FIG. 6. The model image in FIG. 6 is different from that of FIG. 5 in that the viewpoint position of a virtual viewpoint is changed from the viewpoint position VP1 in the rear of model vehicle MC to the viewpoint position VP3 which is directly above (right above) the model vehicle MC. The change is made by a user's operation of the display 21 having a touch panel function, or the operation unit 22.

Further, along with the change of a viewpoint position, a field-of-view range is also changed from the field-of-view range FE1 corresponding to the viewpoint position VP1 to a field-of-view range FE3 corresponding to a viewpoint position VP3. As a result, it is possible to receive a change in a viewpoint position of a virtual viewpoint while outputting a model image that indicates a field-of-view range from a virtual viewpoint for a vehicle. Further, by outputting, to a display device, information corresponding to a model image of a changed field-of-view range according to a change in a viewpoint position of a virtual viewpoint, it is possible to grasp at a glance which area around a vehicle will be displayed to a display device as a synthetic image on the basis of viewpoint positions of virtual viewpoints. Because of this, a user can avoid a cumbersome process in which, after setting up a position of a virtual viewpoint to be displayed as a synthetic image, if the synthetic image is not a desired one, the user should repeat the setup process from the start.

Further, the selected viewpoint position is displayed in a different mode from other viewpoint position possibilities. As a result, a user can see on a display device and verify at a glance a viewpoint position being selected.

In order to differentiate a display mode of a selected viewpoint position from that of unselected viewpoint position, a different brightness can be applied to each display mode. For example, a bright color (light reflecting colors such as yellow, red and the like) can be applied to a selected viewpoint position, while a dark color (light blocking colors such as black, gray and the like) can be applied to an unselected viewpoint position.

With a viewpoint position shifted from VP1 to VP3, the vicinity of a roof spoiler at the upper portion of rear glass in the rear of a vehicle (in FIG. 6, a dead angle area FS3 colored in black) is displayed as a dead angle range from the viewpoint position VP3 of a virtual viewpoint. The range of a dead angle from a viewpoint position selected by a user is displayed in a different mode from that of the field-of-view range FE3. As a result, a user can verify at a glance a region that is not displayed in a synthetic image, as the region being a dead angle from a virtual viewpoint selected by a user.

In order to differentiate a display mode of a field-of-view range from that of a dead angle region, a different brightness can be applied to each display mode. For example, a bright color (light reflecting colors such as yellow, red and the like) can be applied to a field-of-view range, while a dark color (light blocking colors such as black, gray and the like) can be applied to a dead angle region.

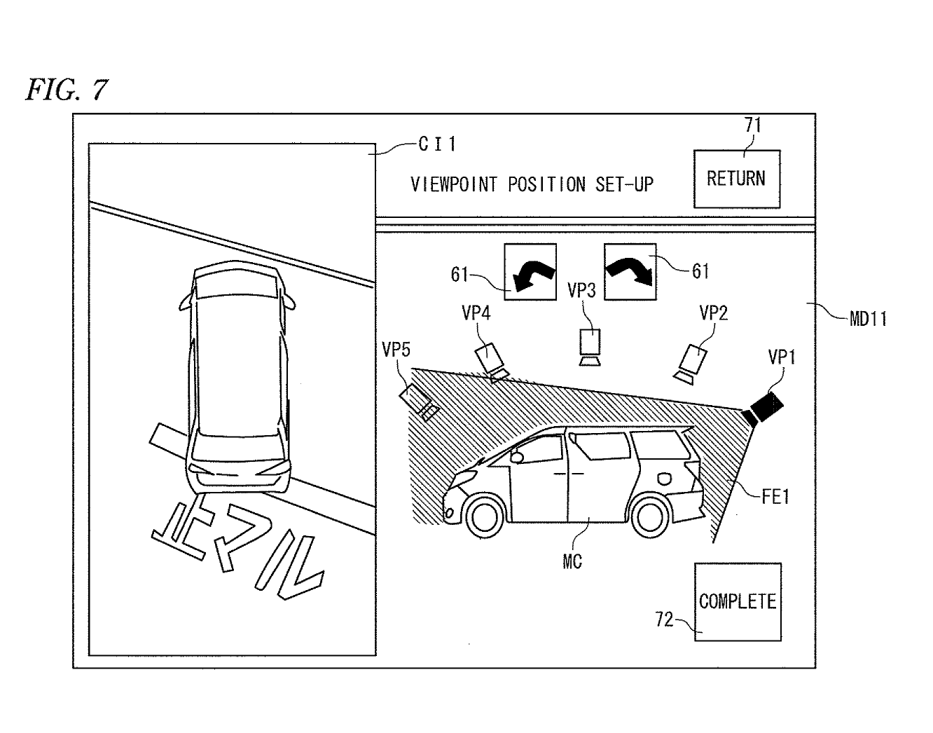

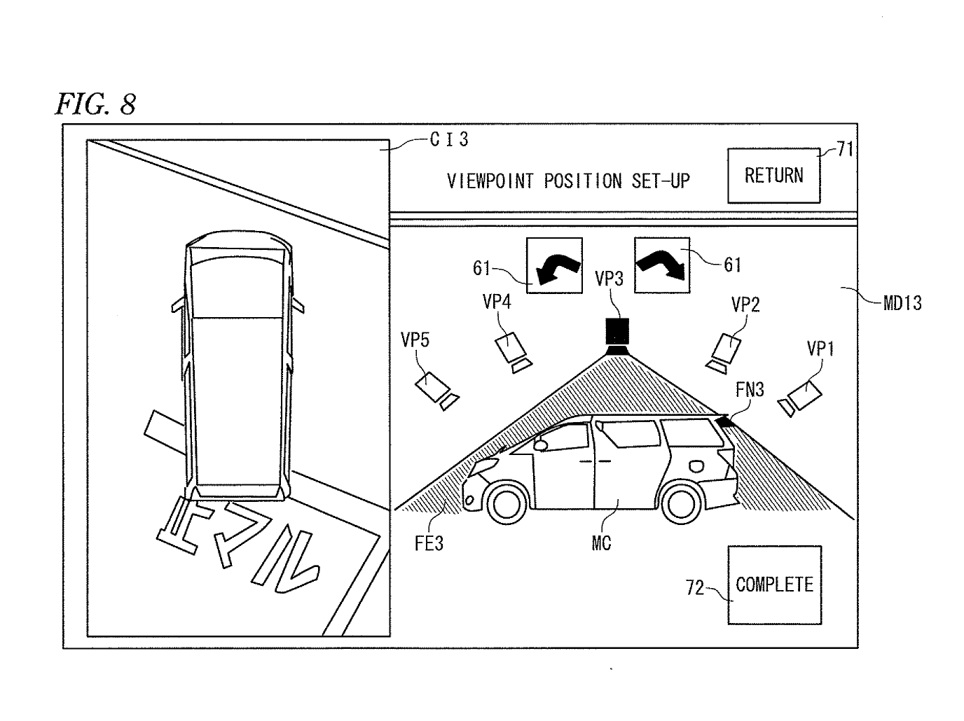

Further, as a different example, Example 1 is shown in FIG. 7 in which a combination of a model image with a synthetic image is displayed on the navigation device 20, while Example 2 is shown in FIG. 8. In FIG. 7, along with the model image described in FIG. 5, a synthetic image C11 which is displayed corresponding to the display range FE1 is displayed on one screen of the navigation device 20. As a result, a user can set up a viewpoint position while confirming on one screen a model image that shows a field-of-view range from a virtual viewpoint for a vehicle, and a synthetic image that is generated on the basis of viewpoint positions of a virtual viewpoint selected by a user.

FIG. 8 illustrates that along with the model image as described above with respect to FIG. 6, a synthetic image C13, which is displayed corresponding to the display range FE3, is displayed on one screen of the navigation device 20. Further, a change of model images and synthetic images shown in FIG. 7 to those in FIG. 8 are made by a user's operation of viewpoint position change icon 61. As a result, a user can change a viewpoint position while confirming a viewpoint position of a virtual viewpoint, and a display range of a synthetic image corresponding to the viewpoint position which is displayed on the navigation device 20.

Meanwhile, in the exemplary embodiments as described above, while the change of the viewpoint positions refers to a change from VP1 to VP3, a change to other viewpoint positions is also possible, and is not limited to the five viewpoint positions described in the exemplary embodiments, and may be a viewpoint position other than those five positions. Further, the number of viewpoint positions may be less than five.

Moreover, when displaying both of a model image and a synthetic image, each may be displayed on a separate screen, other than being displayed on one screen altogether.

<2. Operation>

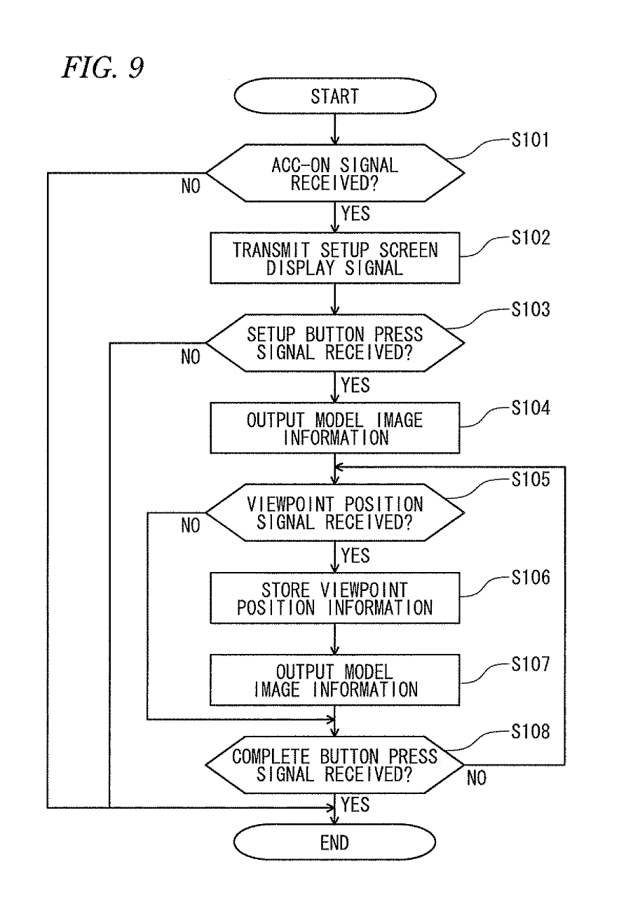

Then, a flow of the setup processing of viewpoint positions through a model image will be described using a flow chart as shown in FIG. 9. When the image processing unit 100 receives the ACC-On signal from a user's operation of the operation unit 22, or the display unit 21 having a touch panel function in order to set up a viewpoint position of a virtual viewpoint of a synthetic image (“Yes” in step S101), information on the setup screen (not shown) stored on nonvolatile memory 40 is output to the navigation device 20 (step S102), and then proceeds to the next process of step S103. On the other hand, if the image processing unit 100 does not receive the ACC-On signal (“No” in step S101), the processing is finished.

Then, in step S103 where a signal indicating that a viewpoint position setup button is pressed is received (“Yes” in step S103) on a setup screen, a model image that indicates a field-of-view range corresponding to a predetermined viewpoint position is read from the model image data 4b of the nonvolatile memory 40, to be output through the output unit 42a to the navigation device 20 (step S104). On the other hand, if the reception unit 42b of the image processing apparatus 100 does not receive the signal that the viewpoint position setup button of the virtual viewpoint is pressed (“No” in step S103), the processing is finished.

Further, in the case of changing a viewpoint position to a certain position by a user's operation of a viewpoint position change icon 61 of a model image displayed on the navigation device 20, if the signal is received by the reception unit 42b (“Yes” in step S105), information on the changed viewpoint position is stored in the nonvolatile memory 40 (step S106).

On the other hand, in the case where the reception unit 42b does not receive the signal that indicates the change of viewpoint positions (“No” in step S105), a model image of the identical viewpoint position remains to be displayed on the navigation device 20, to proceed to the next processing of step S108.

After information on the viewpoint position is stored in step S106, model image information that indicates a field-of-view range corresponding to the changed viewpoint position is read from model image data 4b, to be output to the navigation device 20 from the output unit 42a (step S107). Through this, it is possible to receive the change of viewpoint positions of virtual viewpoints while outputting a model image that indicates a field-of-view range from a virtual viewpoint for a vehicle.

Further, by outputting a model image of a changed field-of-view range according to the change of viewpoint positions of virtual viewpoints, it is possible to confirm at a glance which area of the periphery of a vehicle will be displayed as a synthetic image on the display device. Because of this, a user can avoid a cumbersome process in which, after setting up a position of a virtual viewpoint to be displayed as a synthetic image, if the synthetic image is not a desired one, the user should return to the setup process from the start.

Then, when a signal indicating that the complete button 72 of the model image is pressed is received (“Yes” in step S108), the processing is finished with the setup of viewpoint position after the change remained, and returns to the screen before pressing the setup button (for example, a navigation mode screen). On the other hand, if the signal that a complete button is pressed is not received (“No” in step S108), the model image remains to be displayed on the navigation device 20. Or, after a predetermined time, a navigation mode screen is returned.

Further, the model data 4b stored in the nonvolatile memory 40 as described above in the processing, or a setup screen data which is not shown may be stored in a memory provided in the navigation device 20 and which is not shown.

<3. Modified Examples>

Although the embodiments of the present invention have been described, the present invention is not limited to the described embodiments, and various modifications may be made. Hereinafter, such modified examples will be described. All forms including the forms described in the above-described embodiments and forms to be described hereinafter may be appropriately combined.

In the above-described embodiment, the image processing device 100 and the navigation device 20 are described as different devices. However, the image processing apparatus 100 and the navigation device 20 may be configured to be arranged in the same housing as an integrated device.

Further, in the above-described embodiment, the display device that displays the image generated by the image processing apparatus 100 is the navigation device 100. However, the display device may be a general display device having no special function such as the navigation function.

Further, in the above-described embodiment, a part of the function that is realized by the control unit 1 of the image processing apparatus 100 may be realized by the control unit 23 of the navigation device 20.

Further, in the above-described embodiment, a part or all of the signals that are input to the control unit 1 of the image processing apparatus 100 through the signal input unit 41 may be input to the navigation device 20. In this case, it is preferable that the signals are input to the control unit 1 of the image processing apparatus 100 through the navigation communication unit 42.

Further, in the above-described embodiment, various kinds of functions are realized by software through the arithmetic operation of the CPU according the program. However, a part of these functions may be realized by an electrical hardware circuit. By contrast, a part of the functions that are realized by the hardware circuit may be realized by software.

Priority is claimed on Japanese Patent Application No. 2010-008827 filed in the Japan Patent Office on Jan. 19, 2010, the contents of which are incorporated herein by reference.

1. An image processing apparatus configured to be installed in a vehicle, comprising:
an image obtaining unit configured to obtain a plurality of camera images captured by a plurality of cameras installed on the vehicle;
a synthetic image generating unit configured to generate, on the basis of the plurality of camera images, a plurality of synthetic images viewed from one viewpoint among a plurality of viewpoints that are different from each other, and which indicate surroundings of the vehicle; and
a model image supplying unit configured to output, to a display device installed on the vehicle, information corresponding to a model figure in which one field-of-view range associated with the one viewpoint among the plurality of viewpoints is indicated selectively, from among a plurality of field-of-view ranges.

2. The image processing apparatus according to claim 1, wherein one viewpoint among the plurality of viewpoints associated with one field-of-view range selected from among the plurality of field-of-view ranges is displayed in the model image in a different mode from other viewpoints among the plurality of viewpoints.

3. The image processing apparatus according to claim 1, wherein a dead angle in one field-of-view range selected from among the plurality of field-of-view ranges is displayed on the model image in a different mode from other regions among the plurality of field-of-view ranges.

4. The image processing apparatus according to claim 2, wherein a dead angle in one field-of-view range selected from among the plurality of field-of-view ranges is displayed on the model image in a different mode from other regions among the plurality of field-of-view ranges.

5. The image processing apparatus according to claim 1, further comprising a synthetic image providing unit configured to output, to the display device, information corresponding to one synthetic image of the plurality of synthetic images associated with one field-of-view range selected from among the plurality of field-of-view ranges.

6. The image processing apparatus according to claim 2, further comprising a synthetic image providing unit configured to output, to the display device, information corresponding to one synthetic image of the plurality of synthetic images associated with one field-of-view range selected from among the plurality of field-of-view ranges.

7. The image processing apparatus according to claim 3, further comprising a synthetic image providing unit configured to output, to the display device, information corresponding to one synthetic image of the plurality of synthetic images associated with one field-of-view range selected from among the plurality of field-of-view ranges.

8. An image processing system configured to be installed on a vehicle, comprising:
a plurality of cameras configured to be mounted on a vehicle;
an image processing apparatus configured to be installed on a vehicle, the image processing apparatus comprising:
an image obtaining unit configured to obtain a plurality of camera images captured by a plurality of cameras installed on the vehicle;
a synthetic image generating unit configured to generate, on the basis of the plurality of camera images, a plurality of synthetic images viewed from one viewpoint among a plurality of viewpoints that are different from each other and which indicate surroundings of the vehicle; and
a model image supplying unit configured to output, to a display device installed on the vehicle, information corresponding to a model figure in which one field-of-view range associated with the one viewpoint among the plurality of viewpoints is indicated selectively, from among a plurality of field-of-view ranges.

9. An image processing method, comprising:
obtaining a plurality of camera images captured by a plurality of cameras installed on the vehicle;
generating, on the basis of the plurality of camera images, a plurality of synthetic images viewed from a plurality of viewpoints that are different from each other and which indicate surroundings of the vehicle; and
outputting, to a display device installed on the vehicle, information corresponding to a model figure in which one field-of-view range associated with the one viewpoint among the plurality of viewpoints is indicated selectively, from among a plurality of field-of-view ranges.
